(19) United States
(12) Patent Application Publication
(10) Pub. No.: US 2014/0083966 A1
(43) Pub. Date: Mar. 27, 2014

(54) LIFTING APPARATUS WITH A MECHANICAL LOCKING SYSTEM

(71) Applicant: Juan Martin Aristi Artolazabal, Berriz (BIZKAIA) (ES)

(72) Inventor: Juan Martin Aristi Artolazabal, Berriz (BIZKAIA) (ES)

(73) Assignee: MELCHOR GABILONDO, S.A., Berriz (Bizkaia) (ES)

(21) Appl. No.: 14/008,842

(22) PCT Filed: Mar. 23, 2012
(86) PCT No.: PCT/ES12/00071

§ 371 Date: Dec. 11, 2013

(30) Foreign Application Priority Data
Mar. 30, 2011 (ES) P 201100368

(51) Int. Cl. B66C 23/48

(52) U.S. Cl. CPC B66C 23/48
USPC 212/261

(57) ABSTRACT

Lifting apparatus (1) provided with a raisable element (4) and a hydraulic system (5), which includes a mechanical locking system based on at least one lock element (7) articulately connected to a free end of a moving rod (5b) of the hydraulic system (5), where the lock element (7) includes an internal slot (8) through which a protuberance (9) attached to a fixed part (5a) of the hydraulic system (5) can move. The internal slot (8) is provided with at least one recess (10) in which the protuberance (9) may be lodged in order to lock the raisable element (4) in different positions. The centre of gravity of the lock element (7) is arranged in such a way that, in an unlock situation, an imaginary line that connects the centre of gravity with the articulated connection between the free end of the moving rod (5b) and the lock element (7) forms a certain angle with the vertical. The locking system locks itself automatically and is easy to use.

### TECHNICAL FIELD

The invention relates to a lifting apparatus of the type used in vehicle repair garages, machine workshops, stores, etc, to lift heavy objects. Such lifting apparatus are equipped with a raisable element to enable the object that is to be lifted to be held, secured or received.

### PRIOR ART

Multiple lifting apparatus designs, to enable a vehicle or other very heavy object to be lifted without the operator having to make any effort and providing safety in use, are known in prior art. These lifting apparatus usually comprise a raisable element capable of being raised or be lowered, operated by a hydraulic system. The free end of the raisable element usually includes a hook, a platform or some other item intended to secure or receive all or part of the object that is wished to be lifted.

As mentioned, the raisable element is operated by means of a hydraulic system comprised in the lifting apparatus. The hydraulic system is responsible not only for enabling the safe, controlled lifting and lowering of the object to be lifted, but also of maintaining it raised at a certain point. This means the hydraulic system must be capable of maintaining the raisable element raised at a given point even when the raisable element is supporting a heavy load.

In order to increase the safety of the lifting apparatus in the hypothetical case that the hydraulic system should fail, an additional mechanical locking system has been applied to certain lifting apparatus so as to lock the position of the raisable element. This mechanical locking is complementary to the locking action of the hydraulic system. In this way, in the event of hydraulic failure, the mechanical locking system ensures that the raisable element of the lifting apparatus continues to hold the object and that the object does not fall, thereby eliminating the serious risk of damage that such an incident might cause, not only to the operator but to the object itself.

One example of these systems can be seen in patent application number EP1775251A1, which shows a lifting apparatus equipped with a base, a column and a raisable element in the form of an articulated arm. The articulated arm in this document is dual, i.e. it consists of two parallel bars, with articulated connections at their respective ends so that an articulated parallelogram is formed. The hydraulic operating system operates on the lower bar. As a mechanical locking system, the arm includes an elongated locking part articulately connected to the articulated connection between the upper bar of the arm and the column. This locking part has a toothed longitudinal groove, along which the articulated connection between the lower bar and the hydraulic system moves (and can be locked into the teeth). In addition to being somewhat complex, this mechanical locking design is obviously only suitable for lifting apparatus equipped with a dual arm.

The goal of the present invention is to provide a mechanical locking system whose design is not excessively complex and that is relatively easy to use.

### BRIEF DESCRIPTION OF THE INVENTION

It is an object of the invention to provide a lifting apparatus which, like other conventional lifting apparatus, comprises a. raisable element and a hydraulic system to cause the rising or lowering of the raisable element. The hydraulic system has a fixed part and a moving rod, the free end of the moving rod being connected to the raisable element by means of a connection. The free end of the moving rod can act on the raisable element to cause it to be raised or lowered. The lifting apparatus according to the invention also has the particularity that it includes at least one lock element articulately connected to the the free end of the moving rod of the hydraulic system, where the lock element comprises an internal slot through which a protuberance attached to the fixed part of the hydraulic system can move. The slot is provided with at least one recess in which the protuberance may be lodged in order to lock the raisable element, where each recess defines a locking position of the raisable element. Additionally, the centre of gravity of the lock element is arranged in such a way that, in the unlock situation, an imaginary line that connects the centre of gravity with the articulated connection between the free end of the moving rod and the lock element forms a certain angle with the vertical. Because of this certain angle, the locking system tends to engage automatically, due to the action of the force of gravity. This simplifies the operation of the locking system and of the lifting apparatus in general.

The mechanical locking system according to the invention, in addition to providing an automatic and therefore simplified locking, provides the additional advantage of being independent of the other items on the lifting apparatus itself so that it could even be considered an accessory adaptable to a conventional apparatus that were not equipped with mechanical locking.

### BRIEF DESCRIPTION OF THE DRAWINGS

Details of the invention can be seen in the accompanying drawings, which do not seek to restrict the scope of the invention:

FIG. 1 shows a perspective view of one embodiment of the lifting apparatus according to the invention.

FIGS. 2 and 3 show two perspective views of the mechanical locking system used in the lifting apparatus in FIG. 1.

### DETAILED DESCRIPTION OF THE INVENTION

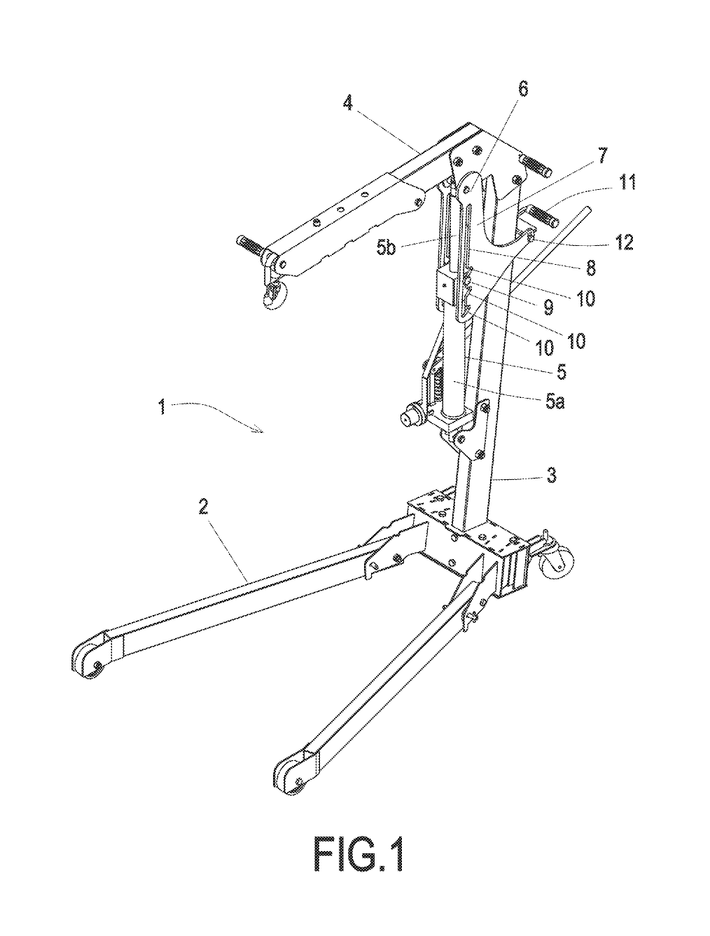

FIG. 1 shows one embodiment of the lifting apparatus according to the invention, which in this case is a crane. As can be seen, the lifting apparatus (1) or crane includes a base (2), at least one column (3)—in this case one—, a raisable element (4) and a hydraulic system (5) to operate the raising or lowering of the raisable element (4). The raisable element (4) is an arm that is articulated in relation to the column (3), The hydraulic system (5) has a fixed part (5a) and a moving rod (5b). The free end of the moving rod (5b) is connected to the raisable element (4) by means of a connection (6). The moving rod (5b) can operate on the raisable element (4) in order to cause it to be raised or lowered.

The lifting apparatus according to the invention further comprises at least one lock element (7) articulately connected to the free end of the moving rod (5b) of the hydraulic system (5). This lock element (7) comprises an internal slot (8) through which a protuberance (9) attached to the fixed part (5a) of the hydraulic system (5) can move. The internal slot (8) is provided with at least one recess (10) in which the protuberance (9) may be lodged in order to lock the raisable element (4) in different positions.

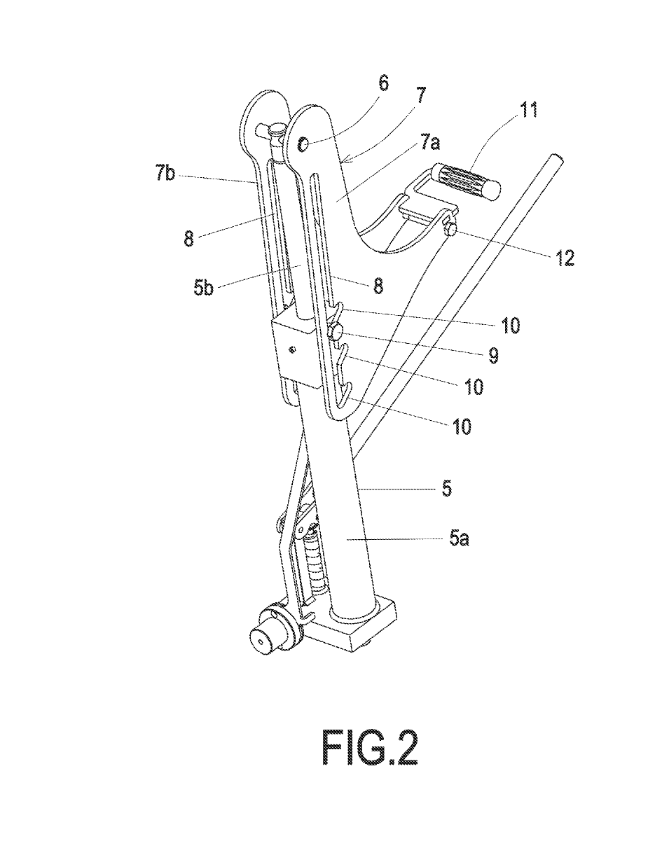

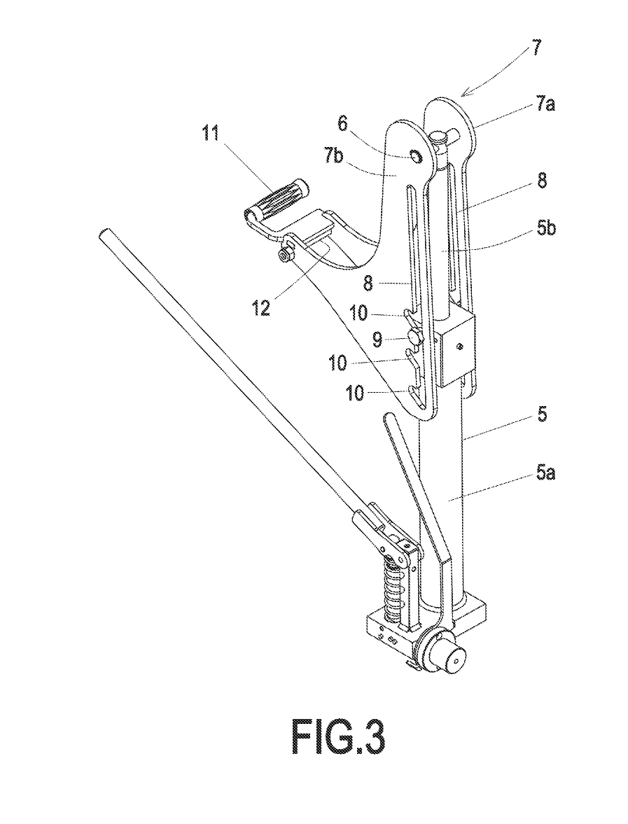

FIGS. 2 and 3 show two perspective views of the locking system described above.

Preferably, as shown in FIG. 1 and especially in FIGS. 2 and 3, the lock element (7) comprises an operating device (11) that enables the user to make the lock element (7) turn in relation to the connection (6) between the lock element (7) and the raisable element (4). Thus, in case the protuberance (9) is lodged in a recess (10), the recess (10) can be detached from the protuberance (9) and therefore the protuberance (9) and the raisable element (4) become unlocked. In this way, by simply using the operating device (11), it is possible to unlock or release the mechanical locking.

Preferably, the operating device (11) is a handle, as shown in the figures. However, other alternative operating devices are not ruled out, if they are able to cause the lock element (7) to turn, as described above.

As regards the preferred embodiment of the lock element (7), said lock element (7) is composed of two plates (7a, 7b) provided with respective identical internal slots (8) through which two respective protuberances attached to the fixed part (5a) of the hydraulic system (5) can move, as shown in FIGS. 2 and 3. The two plates (7a, 7b) are arranged one on each side of the moving rod (5b) of the hydraulic system (5). This embodiment is considered very suitable because it is relatively simple to manufacture and assemble onto the other elements of the lifting apparatus (1), and at the same time it provides optimal robustness and operation.

As shown in the figures, the plates (7a, 7b) are preferably linked by the handle and fixed by a bolt (12), always maintaining a correct relative position between them.

In the embodiment shown in the figures, the connection (6) between the free end of the moving rod (5b) and the raisable element (4) is an articulated connection. Additionally, the lock element (7) is articulately connected to said articulated connection (6) between the free end of the moving rod (5b) of the hydraulic system (5) and the raisable element (4). In other words, the free end of the moving rod (5b), the raisable element (4) and the lock element (7) are connected to a single articulated connection. This allows the mechanical locking system of the invention to be suitable for arms of any configuration: single (formed by a single bar or beam), double (formed, for example, by two parallel bars as shown in document EP 1775251A1), etc. Also, this allows to simplify the mechanical locking system, as it takes advantage of an existing articulated connection to connect the lock element, instead of requiring an additional articulated connection specifically for this purpose. Thus, the invention avoids unnecessary complexities.

In the embodiment shown, the fixed part (5a) of the hydraulic system (5) is articulately connected to the column (3), although this fact is not relevant for the present invention and other alternative constructions are not ruled out.

1. Lifting apparatus (1), which comprises a raisable element (4) and a hydraulic system (5) to produce the rising or lowering of the raisable element (4), where the hydraulic system (5) has a fixed part (5a) and a moving rod (5b), where the free end of the moving rod (5b) is connected to the raisable element (4) by means of an connection (6) and can act on the raisable element (4) to cause it to be raised or lowered, which is characterized in that it includes:
at least one lock element (7) articulately connected to the free end of the moving rod (5b) of the hydraulic system (5), wherein
the lock element (7) includes an internal slot (8) through which a protuberance (9) attached to the fixed part (5a) of the hydraulic system (5) can move,
the internal slot (8) being provided with at least one recess (10) in which the protuberance (9) may be lodged in order to lock the raisable element (4) in different positions,
the centre of gravity of the lock element (7) is arranged in such a way that, in an unlock situation, an imaginary line that connects the centre of gravity with the articulated connection between the free end of the moving rod (5b) and the lock element (7) forms a certain angle with the vertical.

2. Lifting apparatus (1), according to claim 1, wherein the lock element (7) includes an operating device (11) that enables the user to make the lock element (7) turn in relation to the articulated connection that connects it to the raisable element (4), so that if the protuberance (9) is lodged in a recess (10), the recess (10) can be detached from the protuberance (9) and therefore the protuberance (9) and the raisable element (4) become unlocked.

3. Lifting apparatus (1), according to claim 2, wherein the operating device (11) is a handle.

4. Lifting apparatus (1), according to claim 1, wherein the lock element (7) is composed of two plates (7a, 7b) provided with respective identical internal slots (8) through which two respective protuberances attached to the fixed part (5a) of the hydraulic system (5) can move, and wherein the two plates (7a, 7b) are arranged one on each side of the moving rod (5b) of the hydraulic system (5).

5. Lifting apparatus (1), according to claim 4, wherein the two plates (7a, 7b) are fixed together by a bolt (12).

6. Lifting apparatus (1), according to claim 1, wherein the operating device (11) is a handle, the lock element (7) is composed of two plates (7a, 7b) provided with respective identical internal slots (8) through which two respective protuberances attached to the fixed part (5a) of the hydraulic system (5) can move, the two plates (7a, 7b) are arranged one on each side of the moving rod (5b) of the hydraulic system (5), and the two plates (7a, 7b) are fixed together by the handle.

7. Lifting apparatus (1), according to claim 1, wherein the connection (6) between the free end of the moving rod (5b) and the raisable element (4) is an articulated connection, and wherein the lock element (7) is articulately connected to said articulated connection (6) between the free end of the moving rod (5b) of the hydraulic system (5) and the raisable element (4).
